(19) United States
(12) Patent Application Publication
(10) Pub. No.: US 2025/0164307 A1
(43) Pub. Date: May 22, 2025

(54) SOUND EVENT DETECTION USING SURFACE MOUNTED VIBRATION SENSORS

(71) Applicant: HARMAN INTERNATIONAL INDUSTRIES, INCORPORATED, Stamford, CT (US)

(72) Inventors: Yu DU, Stamford, CT (US); Darin KRAJEWSKI, Stamford, CT (US); Viktor DOBOS, Stamford, CT (US); Pablo DIEGO REGLA, Stamford, CT (US)

(73) Assignee: HARMAN INTERNATIONAL INDUSTRIES, INCORPORATED, Stamford, CT (US)

(21) Appl. No.: 18/834,942

(22) PCT Filed: Mar. 30, 2022
(86) PCT No.: PCT/US2022/022676

§ 371 Date: Jul. 31, 2024

(51) Int. Cl. G01H 3/00; G01H 11/06

(52) U.S. Cl. CPC G01H 3/00; G01H 11/06

(57) ABSTRACT

A method for detecting a sound field in an outside environment of a solid structure is provided. The solid structure comprises at least one sound transducing element, which is a part of the solid structure and forms a part of an outer surface of the solid structure, wherein the incident sound falls at least partly onto the sound transducing element. The method comprises obtaining sensor data from at least one vibration sensor, which is mounted onto a mounting surface of the at least one sound transducing element, wherein the at least one vibration sensor detects vibrations in the at least one sound transducing element, which are induced into the at least one sound transducing element by the incident sound field, processing the sensor data to generate output data, and providing the output data.

### CROSS-REFERENCE TO RELATED APPLICATION

This application is the U.S. national phase of PCT Application No. PCT/US2022/022676 filed on Mar. 30, 2022 the disclosure of which is hereby incorporated in its entirety by reference herein.

### TECHNICAL FIELD

Various examples of the disclosure generally relate to sound event detection using a vibration sensor attached to a surface of a solid structure, such as a vehicle, or a building, or an electronic device. Various examples of the disclosure specifically relate to sound event detection using a vibration sensor mounted to a surface of a sound transducing element, which is included in a solid structure and exposed to the sound field on an outer surface of the solid structure.

### BACKGROUND

With the growth of safety, driving assistance technologies and autonomous driving vehicles, the demands for acoustic and non-acoustic situation and event monitoring around the vehicle have grown extensively. Due to the development of these technologies, it has become necessary to detect sounds originating from the outside of the vehicle. Such sounds may include sirens from emergency vehicles (e.g., police car, fire truck, ambulance), wake-up words or voice command words, knocking sounds from pedestrians or foreign object hitting on the vehicle body, and other alerting acoustic events happening in the surroundings of the car (e.g., tire explosion, traffic accident, firearm shot). For that reason, a given number of sensors is required to be integrated in the vehicle to monitor and detect these acoustic events. These sensors should withstand the usage of the car in all driving scenarios and be designed to withstand external agents such as water, ice, dust, or debris that could potentially alter the performance of any sensor and jeopardize the performance of the intended system.

Commonly used for detecting sound fields are acoustic microphones that rely on a direct air path to sense sound, however such acoustic microphones may be easily damaged in harsh surrounding environments.

### SUMMARY

Accordingly, there is a need for advanced techniques for detecting a sound field in an environment around a solid structure. In particular, there is a need for techniques that alleviate or mitigate at least some of the above-identified restrictions and drawbacks.

This need is met by, among other things, the features of the independent claims. The features of the dependent claims define further advantageous examples.

In the following, one solution according to the present disclosure is described, among other things, with regard to the claimed methods as well as with regard to the claimed systems, wherein features, advantages, or alternative embodiments can be assigned to the other claimed objects and vice versa. In other words, the claims related to the systems can be improved with features described in the context of the methods, and the methods can be improved with features described in the context of the systems.

A method is provided for detecting a sound field around a solid structure, such as a vehicle, or a building, or an electronic device, for example, an electronic consumer device. Such a sound field may be generated by a sound event in the surrounding environment. The surrounding environment may have an atmosphere of a gas or liquid medium. The surrounding gas or liquid medium may have an interface to the solid structure. The incident sound may propagate in the surrounding gas or liquid medium towards the solid structure, and impact onto the solid structure, where the sound may be partially reflected and/or partially absorbed, thereby generating vibrations in a solid-state body of the solid structure. It is to be understood that the disclosed techniques may be applied to any kind of solid structure, which may be surrounded by a sound carrying medium, for example, air or water, through which an incident sound may propagate and fall onto the solid structure.

The solid structure comprises at least one sound transducing element, which is a part of the solid structure and forms at least a part of an outer surface of the solid structure, wherein the sound field falls at least partly onto the sound transducing element.

In a step, sensor data is obtained from at least one vibration sensor, which is mounted onto a mounting surface of the sound transducing element, wherein the vibration sensor detects vibrations in the sound transducing element, which are induced into the sound transducing element by the incident sound field. In another step, the sensor data is processed, in order to generate output data, and in a further step, the output data is provided.

Furthermore, a system is provided, and the system is configured for detecting a sound field incident on a solid structure, such as for example a vehicle, or a building, or an electronic device.

The solid structure comprises at least one sound transducing element formed of a solid material, which may be a part of the solid structure, and which may have an outer surface, onto which the sound field may fall. In other words, the sound transducing element forms an outside surface of the solid structure and the sound field falls at least onto a part of the transducing element. A solid material may be a material, to which a vibration sensor may be mechanically fixed, in contrast to a medium such as air or water.

The system further comprises at least one vibration sensor mounted to the sound transducing element, wherein the vibration sensor detects vibrations induced into the sound transducing element by the incident sound field.

The system further comprises at least one computing device configured to obtain sensor data from the at least one vibration sensor, process the sensor data, in order to generate output data, and provide the output data. In this regard, a computing device may be realized at least partly or completely as a remote computing device and/or a cloud-computing resource.

The system may be configured to perform any method or combination of methods according to the present disclosure.

A computing device is provided comprising at least one processor and memory, the memory comprising instructions executable by the processor, wherein when executing the instructions in the processor, the computing device is configured to perform the steps of any method or combination of methods according to the present disclosure.

A computer program or a computer-program product and a computer-readable storage medium including program code is provided. The program code can be executed by at least one processor. Upon executing the program code, the at least one processor performs any method or combination of methods according to the present disclosure.

For the system, computing device, and computer program, advantages may be realized, which correspond to the advantages described for the methods.

It is to be understood that the features mentioned above and features yet to be explained below can be used not only in the respective combinations indicated, but also in other combinations or in isolation, without departing from the scope of the present disclosure. In particular, features of the disclosed embodiments may be combined with each other in other embodiments.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

These and other objects of the invention will be appreciated and understood by those skilled in the art from the detailed description of the preferred embodiments and the following drawings in which like reference numerals refer to like elements.

FIG. 1 illustrates a vehicle including a plurality of vibration sensors mounted to outer vehicle panels, according to various examples.

FIG. 2 schematically illustrates steps of a method for detecting a sound field incident on a solid structure, according to various examples.

FIGS. 3 to 6 illustrate vibration sensors mounted to sound transducing elements included in a solid structure, according to various examples.

### DETAILED DESCRIPTION OF EXAMPLES

In the following, embodiments of the invention will be described in detail with reference to the accompanying drawings. It should be understood that the following description of embodiments is not to be taken in a limiting sense. The scope of the invention is not intended to be limited by the embodiments described hereinafter or by the drawings, which are taken to be illustrative examples of the general inventive concept. The features of the various embodiments may be combined with each other, unless specifically noted otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, elements, or other physical or functional units shown in the drawings or described herein may also be implemented by an indirect connection or coupling.

Hereinafter, techniques will be described that relate to detecting a sound field incident onto a solid structure, in particular to detecting a sound event, and identifying a sound event type.

Some examples of the present disclosure generally provide for a plurality of sensors or other electrical processing devices. All references to the circuits and other electrical devices and the functionality provided by each are not intended to be limited to encompassing only what is illustrated and described herein. It is recognized that any sensor or other processing device disclosed herein may include any number of microcontrollers, a general-purpose central processing unit (CPU), a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed. In various examples, processing devices may be embodied as remote or cloud computing devices. It is to be understood, that other sensors may be used for detecting vibrations in solid-state bodies, including sensor arrangements with optical, mechanical, electro-magnetic, or capacitive structures, which may be used, in order to detect a vibration in a solid-state body of a sound transducing element.

With the growth of safety, driving assistance technologies and autonomous driving vehicles, the demands for acoustic and non-acoustic situation and event monitoring around the vehicle have grown extensively. Due to the development of these technologies, it may be necessary to detect sounds originating from the outside of the vehicle. Such sounds may include sirens from emergency vehicles (e.g., police car, fire truck, ambulance), wake-up words or voice command words, knocking sounds from pedestrians or foreign object hitting on the vehicle body, and other alerting acoustic events happening in the surroundings of the car (e.g., tire explosion, traffic accident, firearm shot). For that reason, a given number of sensors is required to be integrated in the vehicle to monitor and detect these acoustic events. These sensors should withstand the usage of the car in all driving scenarios and be designed to withstand external agents such as water, ice, dust, or debris that could potentially alter the performance of any sensor and jeopardize the performance of the intended system.

Comparing to the most commonly used acoustic microphone that relies on a direct air path to sense sound, a surface vibration sensor is typically sealed to the environment, thus may be used in much harsher environments. Furthermore, the surface vibration sensor may be mounted on the B-side (or A-side) surface of the vehicle's elements, such as windows, car trim, doors, or other elements. With this integration scheme, the sensor is not directly exposed to external agents such as water or ice. Therefore, the surface vibration sensor may provide more reliable and consistent performance for automotive external sound event detection.

The present disclosure describes an approach to detect automotive external sound or acoustic events using surface mountable vibration sensors. Sound causes vibration as it travels through a medium. The sound induced vibration motion may be sensed by an acoustic microphone (in case the medium being air) or a vibration sensor like an accelerometer or a dynamic strain/stress sensor (in case the medium being a solid structure such as the glass, plastic, or metal surfaces, or a composite material of a vehicle). The sensor output may be processed, analyzed, and compared to a library of sound signatures corresponding to selected sound types. Finally, a certain type or types of sound events occurring outside of the vehicle may be identified, and then a corresponding warning decision may be sent to the vehicle infotainment system (e.g., head unit, audio system) to alert or warn the driver and passengers.

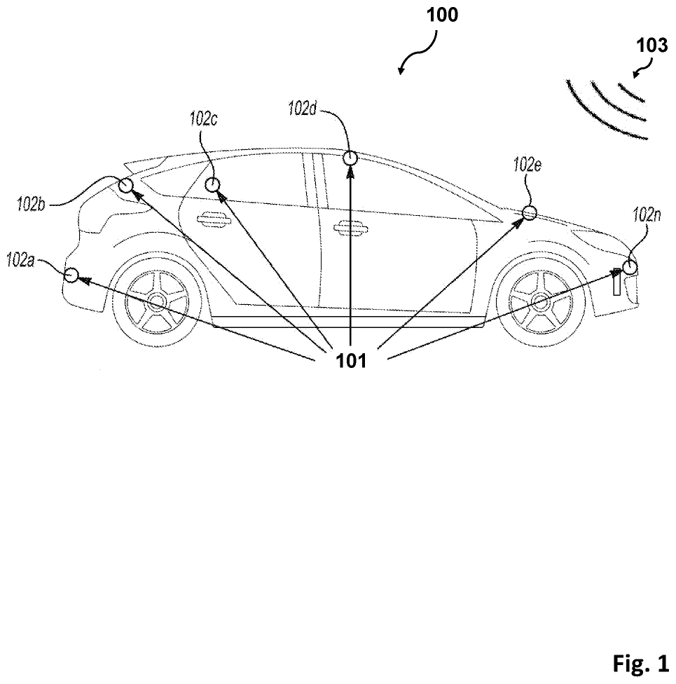

FIG. 1 illustrates a vehicle 100 including a plurality of vibration sensors 102a-n mounted to outer vehicle panels 101, according to various examples.

As can be seen in FIG. 1, the vehicle 100 may be an example for a solid structure, which is constructed of a plurality of solid elements, which together form an outer surface in direct contact to an outside environment, e.g. air in the example of FIG. 1. The outer surface of the vehicle 100 if formed of a plurality of vehicle panels 101, which are vehicle body parts of a solid state material, and on which the vibration sensors 102a-n are mounted. The vehicle panels 101 may represent sound transducing elements of the vehicle 100. Outer surfaces of the vehicle panels 100 are part of the outside surface of the vehicle 100, which is visible and in direct contact to the surrounding environment. Therefore, an incident sound field from the surrounding medium will generate oscillating movement in the vehicle panels 101, as the sound energy is introduced into these panels and propagates within the panels. In this example, the vibration sensors are mounted to the vehicle panels onto surfaces in the inside of the vehicle, such that the vibration sensors 102a-n are protected from the outside environment by the vehicle panels 101. An incident sound field 103 is generated by a sound event outside the vehicle in the surrounding environment at a location in front of the vehicle 100. The incident sound 103 propagates through air towards the vehicle 100 and impacts on the outer surface of the vehicle. By the incident sound field, vibrations are generated in at least the vehicle panels 101, onto which the vibration sensors are mounted. In other words, the incident sound is induced into the sound transducing elements of the solid structure, where the sound propagates as vibrations within the sound transducing elements to the vibration sensors 102a-n. The vibration sensors 102a-n sense and detect the oscillating movements, i.e. vibrations, of the sound transducing elements and output measurement data representing the vibrations.

The vehicle 100 may further comprise a computing device, configured for processing the vibration sensor data. The vehicle 100 may also comprise a network interface, which may be used to transmit the sensor data over a communication network to a remote processing device or a cloud-based processing device.

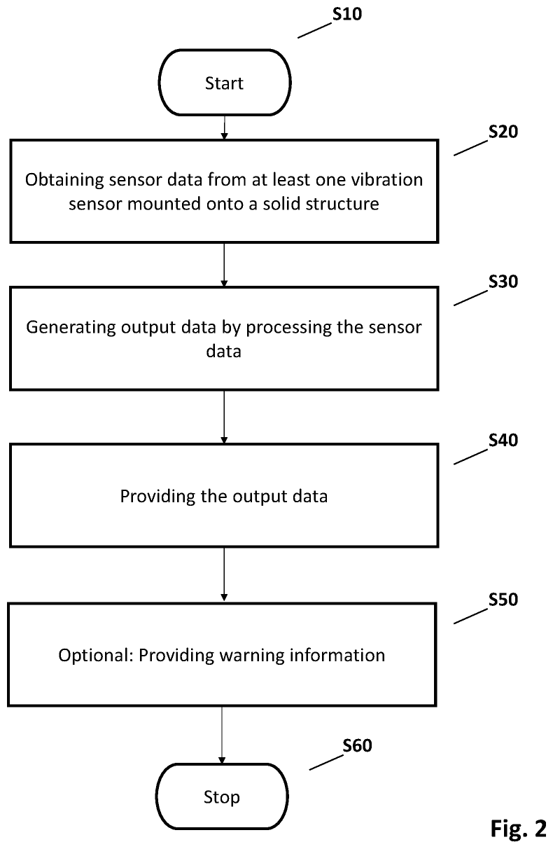

FIG. 2 schematically illustrates steps of a method for detecting a sound field incident on a solid structure, according to various examples.

The method starts in step S10.

In step S20 sensor data is obtained from at least one vibration sensor mounted onto a solid structure, wherein the sensor data corresponds to measurement data of vibrations generated in the solid structure, particularly a sound transducing element of the solid structure, by an incident sound field.

In various examples, external sound events may be monitored by one or more vibration sensors 102 mounted on the vehicle 100 surfaces, i.e. sound transducing or transmitting vehicle parts with an outside surface 101, such as windshield glass, metal body panel and roof, and plastic bumper plate, etc. The vibration sensor 102 may be in the form of an accelerometer or dynamic strain/stress sensor that measures the acceleration, deformation and/or force resulted from the structural vibration. In case of accelerometers, the sensing axis is best oriented to be perpendicular to the mounting surface, while the sensing direction is in parallel (i.e., in-plane) with the mounting surface in the case of dynamic strain/stress sensor. In other words, the vibration sensor mounted on a vehicle surface picks up sound signals in the sound transducing element, and outputs sensor data, i.e. a sensor measurement signal, which represents the vibrations detected in the sound transducing element 101.

In step S30 the sensor data is processed, in order to generate output data.

In various examples, the sensor output signal is fed into an acoustic signal processing and feature extraction module (ASPFEM). The ASPFEM analyzes the signal, extracts features such as time-domain and frequency-domain characteristics of the signal, compares the extracted features with a library of sound signatures corresponding to selected critical sound types, which is pre-determined knowledge, and identifies the sound event(s). The identified sound events, e.g. sound event types, may be an output of the processing of the sensor data.

In step S40, the determined output data is provided. For example, the output data may be provided to a central processing device of a vehicle, wherein the output data may be further used in e.g. security applications.

In an optional step S50, warning information corresponding to the determined sound event type is provided to a user. For example, the system outputs a warning decision to the vehicle infotainment system to warn the drive and passengers inside.

The method ends in step S60.

In addition to detecting the type of the automotive external emergency sound event, the relative incoming direction of the sound event may also be determined by comparing multiple channels of signals coming from the surface vibration sensors mounted at various locations of a vehicle such as front, rear, left and right sides of the vehicle.

The sensor data may be directly provided to a processing device, which may be a computing device or processor for example, or may be temporarily stored in memory and provided to the computing device from the memory. The sensor data may also be transferred to a remote and/or cloud computing resource for the processing, wherein the output data may be transferred back to the vehicle over wired or wireless communication networks.

Processing may comprise determining a sound event and/or a sound event type, which generated the sound field.

Sound or acoustic events picked up and detected through this approach may correspond to one or more of the following sound event types:

An Emergency Vehicle Detection, wherein an information and/or alert is provided from the presence of emergency vehicle sounds, sirens or other acoustic alerts in the surroundings and/or it is detected and provided which type of first responder is present.

Events happening around the vehicle, for example pedestrians, workers or first responders around the car, accidents, or construction going on around the road, etc.

Communication events, such as a Human-Machine communication including wake up words or more complex commands, and/or Inside-Outside communication including for example a dialog between the exterior and the interior of a car or a building.

In various examples, processing may comprise processing the sensor data in a neural network, in order to directly generate the output data. In various examples, applying the trained function may comprise applying an end-to-end trained network.

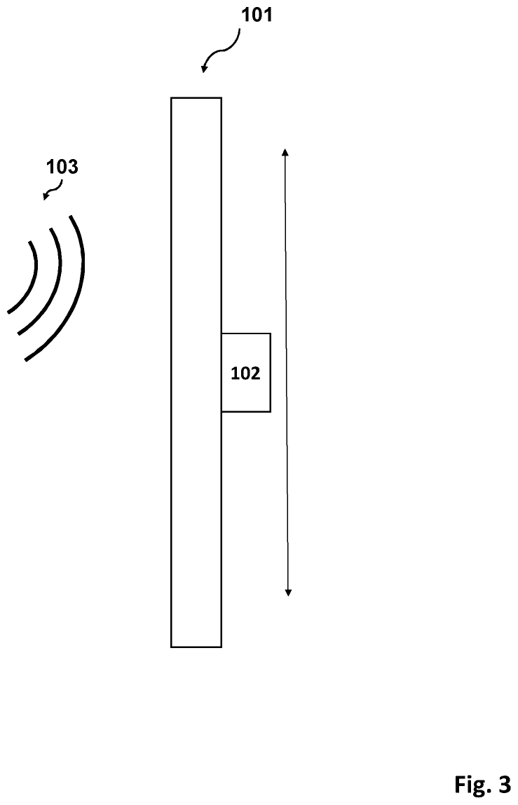

FIGS. 3 to 6 illustrate vibration sensors 102 mounted to sound transducing elements 101, according to various examples.

As can be seen in FIG. 3, the sound transducing element 101 is depicted without the solid structure 100, of which it is a part of. For example, the sound transducing element 101 may be fixed to other parts of the solid structure 100. In various examples, the sound transducing element 101 may be a vehicle panel.

The front side of the sound transducing element 101 may be exposed to an outside environment, including gas or fluid mediums, in which a sound field 103 propagates towards the front side of the sound transducing element 101. As the incident sound field 103 hits the front surface of the sound transducing element 101, vibrations are induced in the samples using element 101.

On the backside of the sound transducing element 11, a vibration sensor 102 is mounted. The vibration sensor 102 may be mounted on a surface opposite the outside surface, on which the incident sound field 103 is impinged. In this regard, the sound transducing element 101 may have a wall thickness, which separates the vibration sensor from the outside environment. As depicted by the arrow, the vibration sensor may be fixed, in other words mechanically connected to the mounting surface of the sound transducing element 101 in various positions along the mounting surface, which will lead to different amplitudes at different frequencies detected by the vibration sensor, depending on the materials of the sound transducing elements used.

In the example of FIG. 3, an acceleration sensor may be used, which senses the vibrations of the sound transducing element 101 in a sensing direction perpendicular to the mounting surface and the impact surface on which the incident sound field is impinged. In other examples, a strain sensor may be used, wherein the strain sensor can measure at least two dimensional strains along the mounting surface of the sound transducing element 101 onto which the strain sensor may be fixedly mounted.

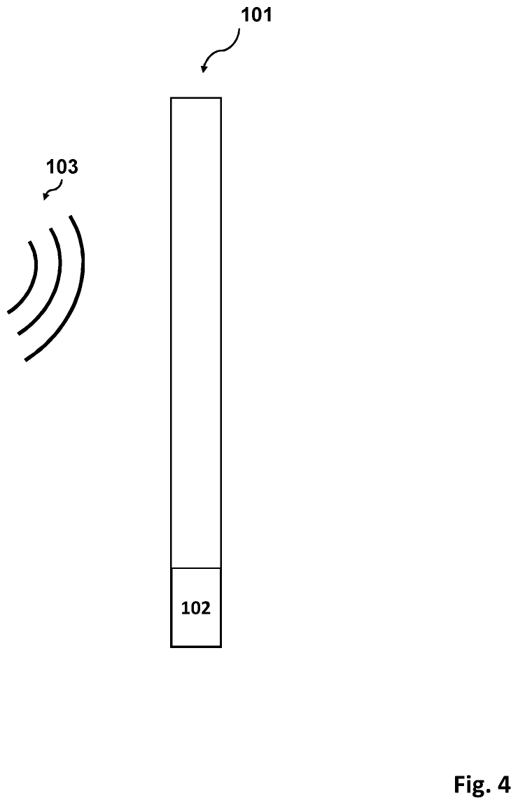

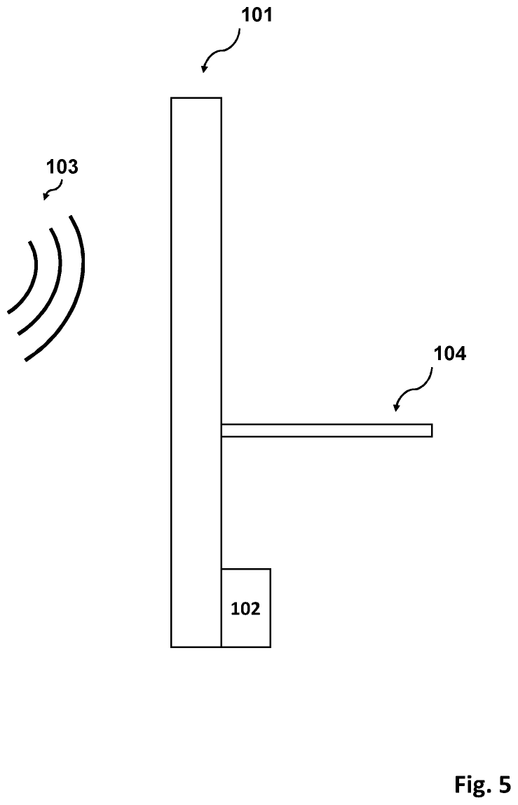

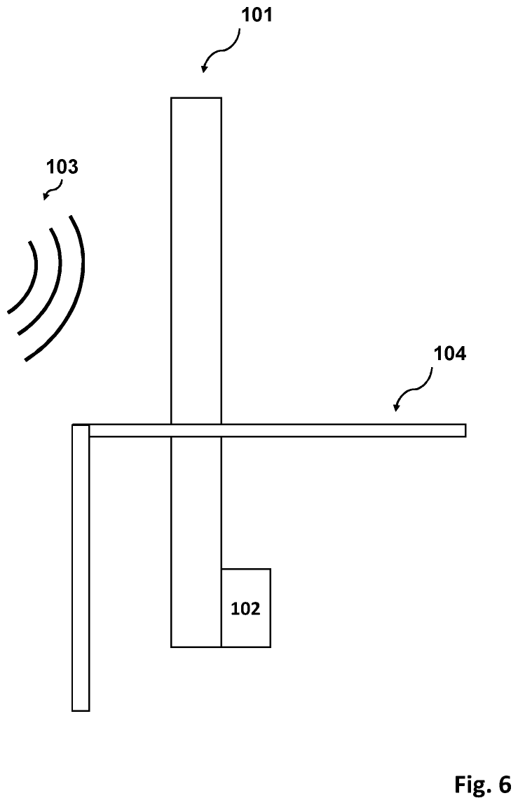

The elements in FIGS. 4 to 6 correspond to the elements as described for FIG. 3, and therefore will not be described in detail. As can be seen in FIG. 4, the vibration sensor 102 may also be mounted to a side surface of the sound transducing element 101. As can be seen in FIG. 5, the vibration sensor 102 may also be mounted onto a region of the sound transducing element 101 which is separated from the sound incident surface by a mounting point onto which another vehicle part 104 is fixed. In this regard, it would for example be possible to mount the vibration sensor 102 on an elongated arm connected to the sound transducing element 101. This may have the advantage that certain frequencies may be amplified. As can be seen in FIG. 6, the vibration sensor 102 may be mounted onto a region of the sound transducing element 101, which is in the inside of the solid structure, such as a free space inside the solid structure, that has no contact to the outside environment. The vibration sensor may provide more design flexibility to be arranged at positions, where it can more easily be sealed and protected from outside influences such as physical contact, humidity, corrosion, and wind.

From the discussion above some general conclusions can be drawn:

The solid structure may be constructed from a plurality of elements formed of a solid material, in other words solid-state material, which may be fixed to each other so as to form the solid structure. In various examples, such a solid structure may form an outside surface, which may be directly exposed to an outside environment, i.e. a sound transmitting medium, which is not a solid-state medium, but may be a gas or liquid, where a sound event may take place. Such a sound event may generate an incident sound in the medium, usually air or water, which may propagate through the gas or liquid medium to impact onto the solid structure.

The solid structure may comprise a sound transducing element, which may be one of the solid elements from which the solid structure is composed of. The sound transducing element may be made of a solid-state material. The sound transducing element may have an outside surface, which may be part of the outside surface of the solid structure. In this regard, the sound field falling onto the outside surface of the solid structure is falling at least in part also onto the outside surface of the sound transducing element. The outside surface of the sound transducing element may be an even surface, for example a plane surface or a curved surface, such as a freeform surface. The sound field may impact the sound transducing element directly, in other words no other mechanical elements, such as grid or grille may be present between the sound event location and the sound transducing element. The sound transducing element may be a monolithic element. The sound transducing element may have a wall thickness of more than 0.1 mm, or more than 0.5 mm, or more than 1 mm. The sound transducing element may be made of glass, or metal, or plastic, or a composite material. The sound transducing element may have the form of a sheet or plate, and for example may exceed an area of 20 mm×20 mm (along the front or back surface, i.e. in a plane substantially perpendicular to the surface normal), in at least one or both directions.

A sound transducing element may be for example a panel of a vehicle, e.g. the outside surface of a vehicle door, a glass window of the vehicle, an outer panel of a building, a front trim of an electronic display device, and similar sheet or plates that form an outside surface accessible, and/or touchable, and/or visible by a user of the solid structure. Such sound transducing elements may, in other words, have an outermost outside surface which is facing towards the outside environment, for example, towards a user, wherein no other part of the solid structure is arranged between a sound event location and the sound transducing element.

When the sound field falls onto the sound transducing element, vibrations may be generated in the sound transducing element as sound energy is introduced into the sound transducing element, and propagates within the sound transducing element, as caused by the incident external sound field. In this regard, the surface vibrations of the mounting surface, to which the vibration sensor is mounted, may represent the incident sound impinging on the sound transducing element. The sound field may not impact the vibration sensor directly, but rather the vibration sensor may be arranged in a position, where the incident sound cannot propagate to directly. In other words, the incident sound may propagate in air towards the solid structure, may impact onto an outer surface of the sound transducing element, whereby the incident sound may induce vibrations in the sound transducing element, the vibrations may propagate from the outer surface through the sound transducing element to a mounting surface of the sound transducing element, to which a vibration sensor may be fixed, wherein the vibration sensor detects oscillating movement of at least part of the mounting surface. In this regard, an outer surface of the solid structure and the sound inducing element may be a surface facing in a direction, where a sound event occurs, and/or facing away from a center, or center of gravity, of the solid structure.

In various examples, the vibrations propagating in the sound transducing element may be transferred directly from the mounting surface to the vibration sensor, as the vibration sensor may be in direct mechanical contact with the mounting surface. The outer surface may correspond to an even surface that is directly facing the surrounding environment, in particular surrounding air. In various examples, it may be possible, that the outer surface of the sound transducing element may correspond to a display surface, on which information or a warning may be displayed. In various examples, the outer surface of the sound transducing element may correspond to a surface of the solid structure that a user may touch, such as a touch input, or a surface that is visible to a user. The area of the outer surface of the sound transducing element, onto which the sound field falls to generate the vibrations may be bigger than 1 cm², bigger than 5 cm², bigger than 20 cm², bigger than 100 cm², or bigger than 1000 cm². The outer surface of the sound transducing element may have a concave curvature, or may have a convex curvature, or may be a plane surface.

In various examples, the complete vibration sensor may be moved in oscillating movements, i.e. vibrations, together with the sound transducing element, particularly the mounting surface, to which the sensor is mounted. For example, the vibration sensor may be an accelerometer, which is mechanically fixed to the transducing element and, therefore, moved together with the mounting surface of the sound transducing element in oscillating movements induced into the sound transducing element by the incident sound field.

In various examples, the incident sound field impacting onto the sound transducing element may represent mechanical stress onto the sound transducing element, wherein the vibrations in the sound transducing element induced by the incident sound field may correspond to mechanical strain in the sound transducing elements, which may be measured by the vibration sensor. The vibration sensor may be a strain sensor which detects an oscillating material strain induced into the sound transducing element by the incident sound field. At least part of a surface of the vibration sensor may be fixed to a mounting surface of the sound transducing element, such that the surface of the vibration sensor is strained together with the sound transducing element.

The method may further comprise obtaining sensor data from the at least one vibration sensor, which is mounted onto a surface of the sound transducing element, wherein the vibration sensor detects vibrations of the mounting surface of the sound transducing element, which are induced into the sound transducing element by the incident sound field.

The method may further comprise processing the sensor data, in order to generate output data, and providing the output data.

In various examples, processing the sensor data may comprise extracting a set of features from the sensor data, wherein the sensor data represents a sound event, which generated the sound field, determining a type of the sound event by comparing the extracted feature set with a plurality of reference feature sets each representing a different sound event type, and providing the sound event type of the sound event, that generated the sound field, as output data.

In various examples, processing the sensor data may comprise determining warning information for the sound event type, and outputting the warning information to a user of the solid structure.

In various examples, processing the sensor data may comprise reconstructing the sound field from the sensor data, and outputting, i.e., replicating, the reconstructed sound field, such that a user can hear the replicated sound field as if he was in the original sound field.

In various examples, processing the sensor data may comprise identifying a physical contact of the solid structure and/or the sound transducing element with another solid-state body and/or gas and/or liquid, e.g. a touch and/or impact and/or crash into the solid structure and/or the sound transducing element. Such physical contact may be detected, identified, and/or classified, wherein corresponding contact information may be provided as output data, e.g. comprising classification information, or a contact type for the physical contact.

In various examples, processing the sensor data may comprise differentiating between a physical contact as described above and a sound field, which may both generate vibrations detected by the vibration sensor in the sound transducing element. Information regarding the sound field may be provided separately from information regarding a physical contact.

In various examples, processing the sensor data may comprise applying a trained function to the sensor data, wherein the trained function is trained with training sensor datasets and corresponding known reference output data. A trained function may for example comprise a neural network, wherein the sensor data is fed into the neural network in order to directly generate the output data. In various examples, applying the trained function may comprise applying an end-to-end trained network.

For example, trained functions may be end-to-end trained functions, which were trained with a plurality of training data sets. A training data set may include input data associated with reference output data. Applying trained functions may be performed by a neural network, which may comprise a plurality of classifier functions. In various examples, trained functions may comprise one or more of known machine learning classifiers. Without limitation, the trained functions may be based for example on one or more of a support vector machine, a decision tree and/or a Bayesian network, k-means clustering, Q-learning, genetic algorithms and/or association rules. For example, a neural network may be a deep neural network, a convolutional neural network, or a convolutional deep neural network, an adversarial network, a deep adversarial network and/or a generative adversarial network, or a model-based machine-learning network architecture.

The output data may comprise a direction, in which a sound event, from which the sound field originates, is located.

The vibration sensor may be mounted to a surface opposite the outside surface, onto which the sound field falls.

The vibration sensor may be sealed by the sound transducing element from the outside environment, which includes the atmosphere of the medium, where the sound field originates, and incident sound propagates.

Multiple vibration sensors may be mounted to the solid structure to respective corresponding multiple sound transducing elements, and wherein the orientation of the surface normals of two sound transducing elements receiving the sound field span at least 90°, preferably 180°.

According to the principles of the present disclosure, the measurement signals generated by one or more vibration sensors attached to a solid-state body, may be clearer, the bigger the outside impact surface of the sound transducing element is, and the thinner a wall thickness, e.g. in direction of the incident sound field, is. The measurement signals, i.e. the sensor data, may be processed to identify a sound event type, or even to reconstruct the sound field to be broadcasted e.g. in an inside of a car. Processing the sensor data may for example comprise performing a voice/speech recognition method based on the sensor data.

In various examples, a sound field, as a space, may be generated and originate from a sound event taking place and generating sound in a medium. The sound of the sound field may propagate in the medium, and specific incident sound waves may have directions, in which they propagate. In various examples, an incident sound may impinge the solid surface from any directions and be picked up by the sound transducing element, e.g. in form of vibrations in the sound transducing element.

The sound transducing element may essentially be a 3D solid-state structure with one dimension significantly smaller than the dimensions in the other two directions, which may be referred to as thickness of the sound transducing element. In other words, the outer surface to be impinged by the incident sound field may essentially extend along a transversal plane (or in x-and y-directions), which may have a surface normal pointing to the outside of the solid structure, wherein a thickness may extend in direction of the surface normal or z-direction.

The sound event may correspond to a sound source, which in some examples may be regarded essentially a point source. If a line is drawn from the point source, i.e. sound event, to the surface location where the vibration sensor is mounted, a maximum signal strength may be obtained when this line happen to be in the direction of the normal direction of the surface (i.e., thickness direction).

The advantages of the disclosed techniques comprise providing one solution to detect automotive external emergency sound events using vibration sensors. It may be difficult for a classical sound sensing microphone to survive the harsh environment condition outside of the car which in turn may make it difficult for a traditional acoustic microphone to be a practical solution for such an application. The vibration sensor can be environmentally sealed and immune to influences from water, snow, ice, dirt, etc.

Furthermore, the vibration sensor functions by sensing the sound induced structure vibration. It can be mounted at any convenient location on a vehicle surface, either external (A-side) or internal (B-side), making its integration into a vehicle much more flexible than integrating an acoustic microphone into a vehicle.

Another benefit that has been demonstrated with preliminary experiment data is that the surface vibration sensor is more immune to wind noise than the traditional acoustic microphone. This is one advantage for external sound detection applications when the car is moving at midrange speeds to high speeds.

In various examples, processing the sensor data may comprise detecting and differentiating a physical contact between the outside surface of the solid structure and/or the sound transducing element and another solid-state body, or a fluid (e.g. rain), or wind, wherein it may be easier and clearer to distinguish between an event comprising a touch, an impact or deformation of the solid structure and/or sound transducing element and a pure sound field. Therefore, for example a touch of the surface, or an impact or a crash onto the solid structure and/or the sound transducing element, causing a sound and/or vibration, and a pure sound event may be more easily detected and identified than with conventional microphones. In various examples, such a vibration sensor may be used together with a conventional microphone, and the signals provided by both may be processed in parallel, in order to more reliably detect sound fields and sound events.

In a preferred example, a sound field around a vehicle may be detected, wherein the sound transducing element may be a panel or a trim of the vehicle, for example of the vehicle body, forming an outer surface of the vehicle. An outer surface may be a continuous surface, in contrast to, for example, a grid. An outer surface may be a surface which is subjected to a sound transmitting medium, such as air, in which a sound event may take place. In various examples, also a vehicle or building interior may be considered a space where a sound event may take place, such that a trim of the vehicle or building facing the sound event in an inner space or room may form an impact surface (i.e. corresponding to the outer surface) to be exposed and impinged to the sound field. In various examples, an outer surface of the sound transducing element may be a surface in contact with a surrounding gas atmosphere, for example, with a direct sound path to the outer surface, wherein the sound directly falls onto the outer sound impact surface. In this regard, the vibrations may be induced in the sound transducing element at the interface between the surrounding gas or liquid medium, e.g. air, and the sound transducing element. In various examples, the sound transducing element may also be a trim inside the vehicle, wherein the sound field may originate from outside the car or inside the car, for example, a conversation or command of a passenger.

Although the disclosed techniques have been described with respect to certain preferred embodiments, equivalents and modifications will occur to others skilled in the art upon the reading and understanding of the specification. The present disclosure includes all such equivalents and modifications and is limited only by the scope of the appended claims.

For illustration, above, various scenarios have been disclosed in connection with a vehicle. Similar techniques may be readily applied to other kinds and types of solid systems, such as for example buildings, electronic consumer devices, or any kind of outdoor or indoor structure, which may comprise a surface of a solid-state material exposed to and receiving sound energy from an external sound field.

1. A method for detecting a sound field around a solid structure, wherein the solid structure comprises at least one sound transducing element, which is a part of the solid structure and forms at least a part of an outer surface of the solid structure, wherein the sound field falls at least partly onto the sound transducing element, the method comprising:
obtaining sensor data from at least one vibration sensor mounted onto a mounting surface of the at least one sound transducing element, wherein the at least one vibration sensor detects vibrations in the at least one sound transducing element, which are induced into the at least one sound transducing element by an incident sound field;
processing the sensor data to generate output data; and
providing the output data.

2. The method according to claim 1, wherein the at least one vibration sensor is an accelerometer, which is moved together with the mounting surface of the at least one sound transducing element in oscillating movements induced into the at least one sound transducing element by the incident sound field.

3. The method according to claim 1, wherein the at least one vibration sensor is a strain sensor which detects an oscillating material strain induced into the at least one sound transducing element by the incident sound field.

4. The method according to claim 1, wherein the solid structure is a vehicle, a building, or an electronic consumer device, and the outer surface of the at least one sound transducing element is an even continuous surface, onto which the incident sound field impacts.

5. The method according to claim 1, wherein processing the sensor data comprises:
extracting a set of features from the sensor data, wherein the sensor data represents a sound event, which generated the incident sound field,
determining a type of the sound event by comparing the extracted set of features with a plurality of reference feature sets each representing a different sound event type, and
providing the type of the sound event as output data.

6. The method according to claim 5, wherein processing the sensor data further comprises:
determining warning information for the type of the sound event, and
outputting the warning information to a user of the solid structure.

7. The method according to claim 1, wherein processing the sensor data comprises:
applying a trained function to the sensor data, wherein the trained function is trained with training sensor datasets and corresponding known reference output data.

8. The method according to claim 1, wherein the output data comprises a direction, in which a sound event, from which the sound field originates, is located.

9. The method according to claim 1, wherein the at least one vibration sensor is mounted to a surface of the at least one sound transducing element opposite the outer surface, which the sound field impacts, or onto the outer surface of the at least one sound transducing element, which the sound field impacts.

10. The method according to claim 1, wherein a sound energy of the incident sound field propagates in air towards the solid structure, falls onto the outer surface of the at least one sound transducing element, whereby the incident sound field induces vibrations in the at least one sound transducing element, the vibrations propagate from the outer surface through the at least one sound transducing element to a mounting surface of the at least one sound transducing element, to which the at least one vibration sensor is fixed, wherein the at least one vibration sensor detects oscillating movement of at least part of the mounting surface.

11. The method according to claim 1, wherein the at least one sound transducing element is formed as a sheet made out glass, plastic, metal, or composite and exceeds an area of 20 mm×20 mm.

12. The method according to claim 1, wherein the at least one vibration sensor is sealed at least partly by the at least one sound transducing element from an outside environment, where the sound field originates.

13. The method according to claim 1, wherein multiple vibration sensors are mounted in the solid structure to respective corresponding multiple sound transducing elements, and wherein an orientation of surface is normal to the sound transducing elements receiving the incident sound field span at least 90°, preferably 180°.

14. A system for detecting a sound field, comprising:
a solid structure comprising at least one sound transducing element formed by a solid-state material, wherein the at least on sound transducing element forms at least part of an outer surface of the solid structure, and the sound field impacts at least onto a part of the at least one sound transducing element;
at least one vibration sensor mounted to the at least one sound transducing element, wherein the at least one vibration sensor detects vibrations induced into the at least one sound transducing element by an incident sound field; and
at least one computing device configured to obtain sensor data from the at least one vibration sensor, process the sensor data to generate output data, and provide the output data.

15. (canceled)

16. A system for detecting a sound field, the system comprising:
a solid structure comprising at least one sound transducing element that forms at least part of an outer surface of the solid structure, and the sound field impacts at least onto a part of the at least one sound transducing element;
at least one vibration sensor mounted to the at least one sound transducing element to detect vibrations induced into the at least one sound transducing element by an incident sound field; and
at least one computing device configured to:
obtain sensor data from the at least one vibration sensor,
process the sensor data to generate output data, and
provide the output data.

17. The system of claim 16, wherein the at least one vibration sensor is an accelerometer, which is moved together with the mounting surface of the at least one sound transducing element in oscillating movements induced into the at least one sound transducing element by the incident sound field.

18. The system of claim 16, wherein the at least one vibration sensor is a strain sensor which detects an oscillating material strain induced into the at least one sound transducing element by the incident sound field.

19. The system of claim 16, wherein the solid structure is a vehicle, a building, or an electronic consumer device, and the outer surface of the at least one sound transducing element is an even continuous surface, onto which the incident sound field impacts.

20. The system of claim 16, wherein the at least one vibration sensor is mounted to a surface of the at least one sound transducing element opposite the outer surface, which the sound field impacts, or onto the outer surface of the at least one sound transducing element, which the sound field impacts.

21. The method according to claim 16, wherein the at least one vibration sensor is sealed at least partly by the at least one sound transducing element from an outside environment, where the sound field originates.
